(19) United States
(12) Patent Application Publication
(10) Pub. No.: US 2025/0125850 A1
(43) Pub. Date: Apr. 17, 2025

(54) DOWNLINK-GRANT DOWNLINK CONTROL INFORMATION ACTIVATED CHANNEL STATE INFORMATION REPORTS

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Yan ZHOU, San Diego, CA (US); Tianyang BAI, Mountain View, CA (US); Tao LUO, San Diego, CA (US)

(21) Appl. No.: 18/834,405

(22) PCT Filed: Mar. 24, 2022
(86) PCT No.: PCT/CN2022/082689

§ 371 Date: Jul. 30, 2024

(51) Int. Cl. H04B 7/06; H04W 24/10; H04W 72/21

(52) U.S. Cl. CPC H04B 7/0626; H04W 24/10; H04W 72/21

(57) ABSTRACT

Various aspects of the present disclosure generally relate to wireless communication. In some aspects. a user equipment (UE) may receive. from a network entity. downlink-grant (DL-grant) downlink control information (DCI) that indicates to activate a first multi-instance channel state information (CSI) report that is based at least in part on a first CSI report setting. the first CSI report setting being related to a second CSI report setting associated with a second multi-instance CSI report. The UE may transmit. to the network entity. the first multi-instance CSI report based at least in part on the first CSI report setting. Numerous other aspects are described.

### FIELD OF THE DISCLOSURE

Aspects of the present disclosure generally relate to wireless communication and to techniques and apparatuses for downlink-grant downlink control information activated multi-instance channel state information reports.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving, from a network entity, downlink-grant (DL-grant) downlink control information (DCI) that indicates to activate a first multi-instance channel state information (CSI) report that is based at least in part on a first CSI report setting, the first CSI report setting being related to a second CSI report setting associated with a second multi-instance CSI report. The method may include transmitting, to the network entity, the first multi-instance CSI report based at least in part on the first CSI report setting.

Some aspects described herein relate to a method of wireless communication performed by a network entity. The method may include transmitting DL-grant DCI that indicates to activate a first multi-instance CSI report that is based at least in part on a first CSI report setting, the first CSI report setting being related to a second CSI report setting associated with a second multi-instance CSI report. The method may include receiving the first multi-instance CSI report based at least in part on the first CSI report setting.

Some aspects described herein relate to a non-transitory computer-readable medium that stores a set of instructions for wireless communication by a UE. The set of instructions, when executed by one or more processors of the UE, may cause the UE to receive, from a network entity, DL-grant DCI that indicates to activate a first multi-instance CSI report that is based at least in part on a first CSI report setting, the first CSI report setting being related to a second CSI report setting associated with a second multi-instance CSI report. The set of instructions, when executed by one or more processors of the UE, may cause the UE to transmit, to the network entity, the first multi-instance CSI report based at least in part on the first CSI report setting.

Some aspects described herein relate to a non-transitory computer-readable medium that stores a set of instructions for wireless communication by a network entity. The set of instructions, when executed by one or more processors of the network entity, may cause the network entity to transmit DL-grant DCI that indicates to activate a first multi-instance CSI report that is based at least in part on a first CSI report setting, the first CSI report setting being related to a second CSI report setting associated with a second multi-instance CSI report. The set of instructions, when executed by one or more processors of the network entity, may cause the network entity to receive the first multi-instance CSI report based at least in part on the first CSI report setting.

Some aspects described herein relate to an apparatus for wireless communication. The apparatus may include means for receiving, from a network entity, DL-grant DCI that indicates to activate a first multi-instance CSI report that is based at least in part on a first CSI report setting, the first CSI report setting being related to a second CSI report setting associated with a second multi-instance CSI report. The apparatus may include means for transmitting, to the network entity, the first multi-instance CSI report based at least in part on the first CSI report setting.

Some aspects described herein relate to an apparatus for wireless communication. The apparatus may include means for transmitting DL-grant DCI that indicates to activate a first multi-instance CSI report that is based at least in part on a first CSI report setting, the first CSI report setting being related to a second CSI report setting associated with a second multi-instance CSI report. The apparatus may include means for receiving the first multi-instance CSI report based at least in part on the first CSI report setting.

Some aspects described herein relate to an apparatus for wireless

communication at a UE. The apparatus may include a memory and one or more processors coupled to the memory. The one or more processors may be configured to receive, from a network entity, DL-grant DCI that indicates to activate a first multi-instance CSI report that is based at least in part on a first CSI report setting, the first CSI report setting being related to a second CSI report setting associated with a second multi-instance CSI report. The one or more processors may be configured to transmit, to the network entity, the first multi-instance CSI report based at least in part on the first CSI report setting.

Some aspects described herein relate to an apparatus for wireless communication at a network entity. The network entity may include a memory and one or more processors coupled to the memory. The one or more processors may be configured to transmit DL-grant DCI that indicates to activate a first multi-instance CSI report that is based at least in part on a first CSI report setting, the first CSI report setting being related to a second CSI report setting associated with a second multi-instance CSI report. The one or more processors may be configured to receive the first multi-instance CSI report based at least in part on the first CSI report setting.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating examples of beam management procedures.

FIG. 4 is a diagram illustrating an example of downlink-grant downlink control information activated multi-instance channel state information reports, in accordance with the present disclosure.

FIG. 5 is a diagram illustrating another example of downlink-grant downlink control information multi-instance channel state information reports, in accordance with the present disclosure.

FIG. 6 is a diagram illustrating an example of a wireless communication process between a base station and a UE in a wireless network, in accordance with the present disclosure.

FIG. 7 is a diagram illustrating an example process performed, for example, by a UE, in accordance with the present disclosure.

FIG. 8 is a diagram illustrating an example process performed, for example, by a network entity, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

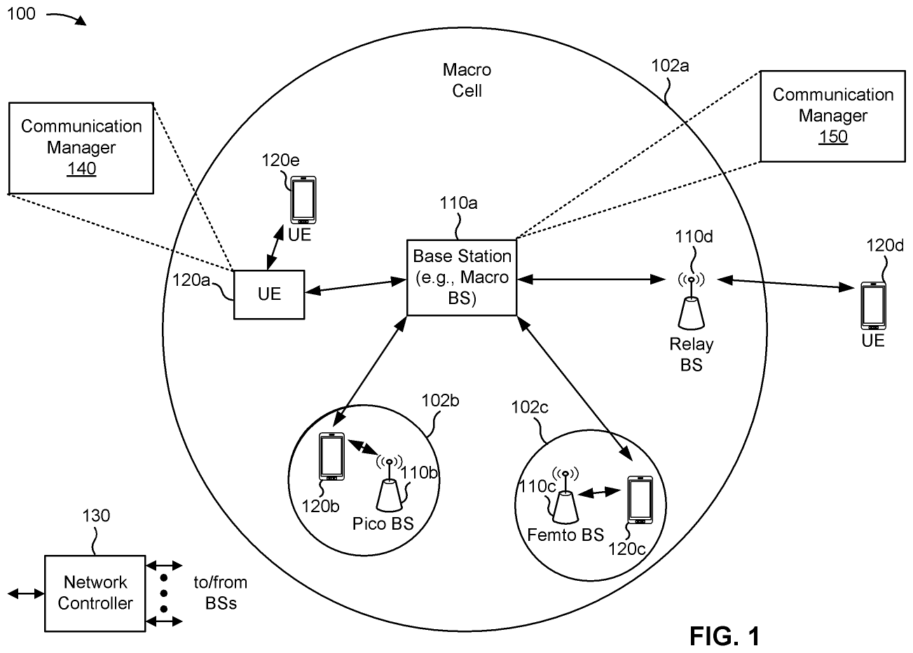

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the

electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FRI and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network entity, downlink-grant (DL-grant) downlink control information (DCI) that indicates to activate a first multi-instance channel state information (CSI) report that is based at least in part on a first CSI report setting, the first CSI report setting being related to a second CSI report setting associated with a second multi-instance CSI report; and transmit, to the network entity, the first multi-instance CSI report based at least in part on the first CSI report setting. Additionally, or alternatively, the communication manager 140 may perform one or more other operations described herein.

In some aspects, the network entity may include a communication manager 150. As described in more detail elsewhere herein, the communication manager 150 may transmit DL-grant DCI that indicates to activate a first multi-instance CSI report that is based at least in part on a first CSI report setting, the first CSI report setting being related to a second CSI report setting associated with a second multi-instance CSI report; and receive the first multi-instance CSI report based at least in part on the first CSI report setting. Additionally, or alternatively, the communication manager 150 may perform one or more other operations described herein.

As indicated above, FIG. 1 is provided as an example. Other examples may differ from what is described with regard to FIG. 1.

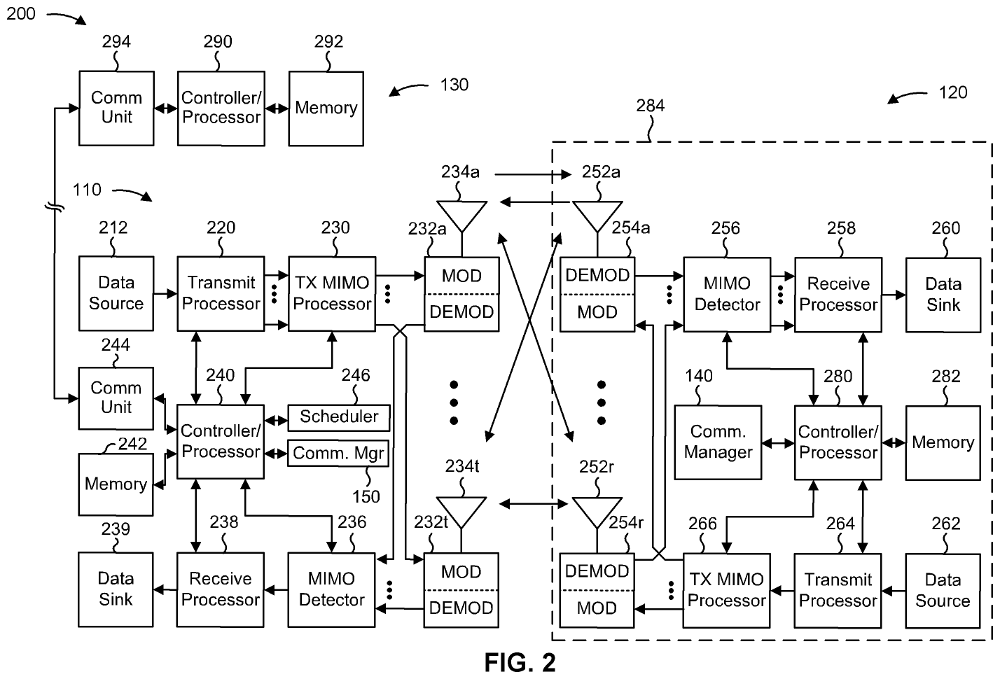

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

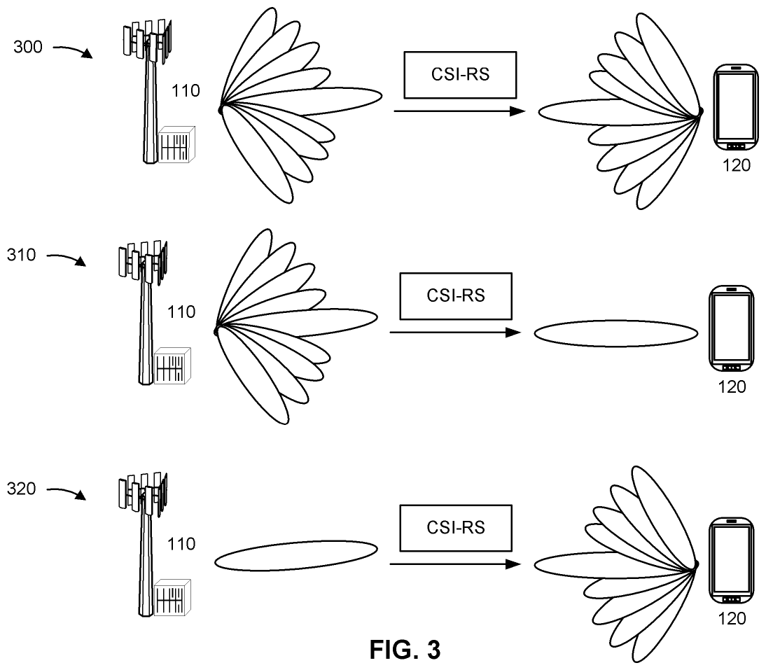

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-10).

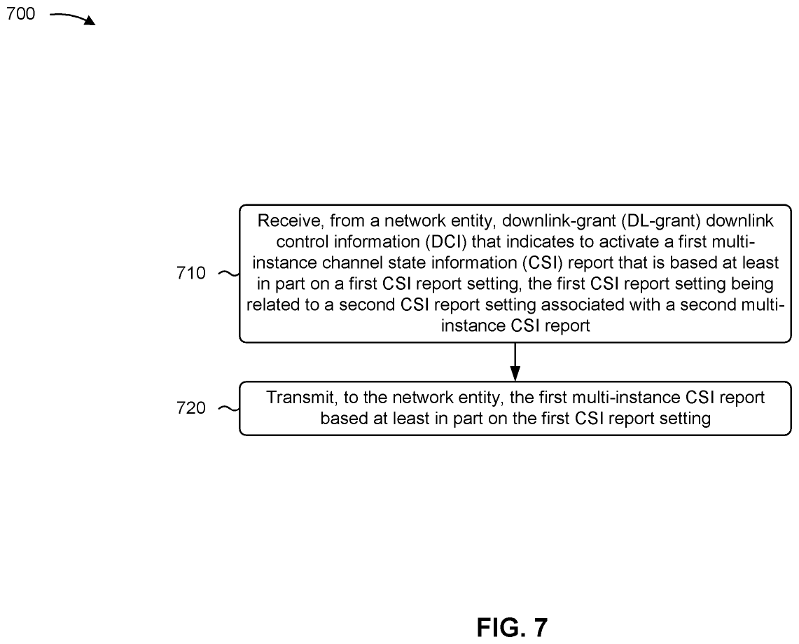

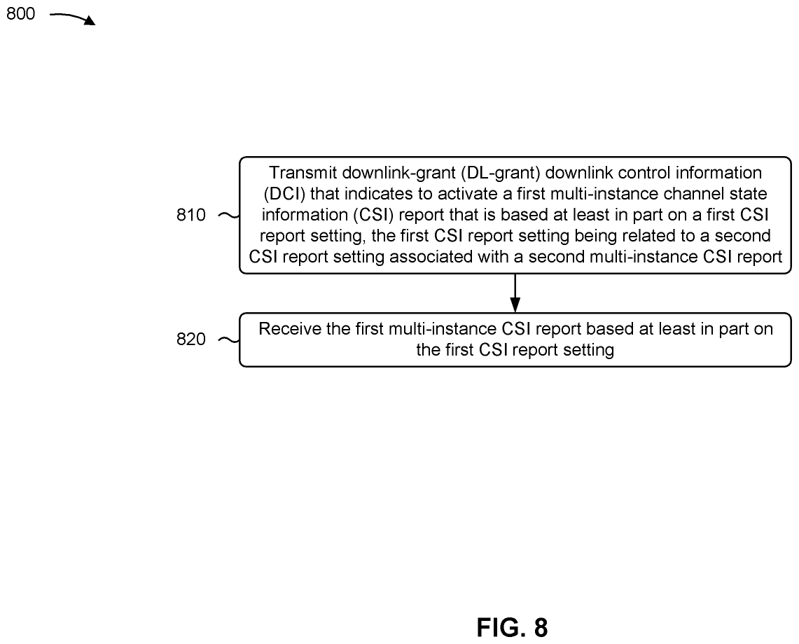

The controller/processor 240 of the base station 110, the controller/processor 280 of the UE 120, and/or any other component(s) of FIG. 2 may perform one or more techniques associated with DL-grant DCI activated multi-instance channel state information reports, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE includes means for receiving, from a network entity, DL-grant DCI that indicates to activate a first multi-instance CSI report that is based at least in part on a first CSI report setting, the first CSI report setting being related to a second CSI report setting associated with a second multi-instance CSI report; and/or means for transmitting, to the network entity, the first multi-instance CSI report based at least in part on the first CSI report setting. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity includes means for transmitting DL-grant DCI that indicates to activate a first multi-instance CSI report that is based at least in part on a first CSI report setting, the first CSI report setting being related to a second CSI report setting associated with a second multi-instance CSI report; and/or means for receiving the first multi-instance CSI report based at least in part on the first CSI report setting. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the network entity to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating examples 300, 310, and 320 of CSI-RS beam management procedures, in accordance with the present disclosure. As shown in FIG. 3, examples 300, 310, and 320 include a UE 120 in communication with a base station 110 in a wireless network (e.g., wireless network 100). However, the devices shown in FIG. 3 are provided as examples, and the wireless network may support communication and beam management between other devices (e.g., between a UE 120 and a base station 110 or transmit receive point (TRP), between a mobile termination node and a control node, between an integrated access and backhaul (IAB) child node and an IAB parent node, and/or between a scheduled node and a scheduling node). Other examples may include alternate or additional network entities in communication with the UE, such as a radio unit, a distributed unit, and/or a central unit of a distributed base station. In some aspects, the UE 120 and the base station 110 may be in a connected state (e.g., an RRC connected state).

As shown in FIG. 3, example 300 may include a base station 110 and a UE 120 communicating to perform beam management using CSI-RSs. Example 300 depicts a first beam management procedure. The first beam management procedure may be referred to as P1 channel state information (CSI)-reference signal (CSI-RS) beam management procedure (P1 CSI-RS beam management procedure), a beam selection procedure, an initial beam acquisition procedure, a beam sweeping procedure, a cell search procedure, and/or a beam search procedure. As shown in FIG. 3 and example 300, CSI-RSs may be configured to be transmitted from the base station 110 to the UE 120. The CSI-RSs may be configured to be periodic (e.g., using RRC signaling), semi-persistent (e.g., using media access control (MAC) control element (MAC-CE) signaling), and/or aperiodic (e.g., using DCI). Other examples of beam management procedures may include uplink beam management procedures that use sounding reference signals (SRS) transmitted by the UE 120, such as a U1 beam management procedure (e.g., an initial selection of an uplink beam by a network entity or the UE), a U2 beam management procedure (e.g., a refinement of the uplink beam by the network entity), and/or a U3 beam management procedure (e.g., a refinement of the uplink beam by the UE).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UJE 120 receive beam(s) beam pair(s). The UE 120 may report the measurements to the base station 110 to enable the base station 110 to select one or more beam pair(s) for communication between the base station 110.

As shown in FIG. 3, example 310 may include a base station 110 and a UE 120 communicating to perform beam management using CSI-RSs. Example 310 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 3 and example 310, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 3, example 320 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 3 and example 320, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

Beam management procedures may improve communications in a wireless network by providing a base station and/or UE with a mechanism to identify beams with better signal quality relative to other beams. Communicating via the wireless network using beams with better signal quality may reduce recovery errors at a receiver, improve data throughput, and/or reduce data-transfer latencies (e.g., by reducing retransmissions) relative to the other beams. Various factors may cause the base station and UE to perform the beam management procedures multiple times, such as the UE moving to a new location, atmospheric changes, and/or changes in interference. The repeated beam management procedures may consume air interface resources (e.g., frequency resources and/or time resources) that the wireless network could otherwise direct to additional devices or use for other transmissions. In some aspects, the repeated beam management procedures may increase data-transfer latencies while the base station and the UE perform each beam management procedure.

In some aspects, a network entity may use prediction algorithms to select a beam and/or beam pairs to reduce signaling overhead associated with beam management procedures and/or to preserve air interface resources in the wireless network. For example, the network entity may select beams and/or beam pairs based at least in part on one or more models trained using a machine learning algorithm (e.g., a deep neural network (DNN) algorithm, a long-short term memory (LSTM) network algorithm, a gradient boosted algorithm, a K-means algorithm, and/or a Random Forest algorithm). Machine learning involves computers learning from data to perform tasks. Machine learning algorithms are used to train machine learning models based at least in part on sample data, known as “training data.” Once trained, machine learning models may be used to make predictions, decisions, or classifications relating to new observations.

In some aspects, the network entity may use, as a prediction algorithm, a machine learning model trained to select beams and/or beam pairs based at least in part on CSI reports from a UE. To illustrate, the network entity may receive periodic CSI reports from the UE (e.g., every 80 milliseconds (msec), every 100 msec) and select the beam and/or beam pair based at least in part on the trained machine learning model and the periodic CSI reports. Using a prediction algorithm to select a beam may reduce signaling between the network entity and the UE and preserve air interface resources.

At times, a prediction algorithm may generate an error, such as a false alarm and/or a missed detection that results in an erroneous prediction (e.g., a beam selection that results in degraded signal quality relative to other beam selections). To illustrate, a prediction algorithm based at least in part on LSTM may have a missed detection prediction (MDP) rate of 24% and a corresponding false alarm prediction (FAP) rate of 23%. The degraded signal quality may increase recovery errors at a receiver and/or increase data-transfer delays (e.g., due to retransmissions). As one example, a missed detection may prevent the network entity from changing a current beam and/or a current beam pair to a different beam or beam pair that may improve signal quality at a receiver. As another example, a false alarm may cause the network entity to change the current beam and/or current beam pair to beam(s) to different beam(s) that introduce signal degradation.

To reduce erroneous predictions, the network entity may trigger a UE to generate one or more supplemental CSI reports to the periodic CSI reports, such as a single measurement report (e.g., a dynamic or aperiodic CSI report) and/or multiple measurement reports (e.g., semi-persistent (SP)-CSI reports) with a smaller periodicity (e.g., 20 msec) relative to the periodic CSI reports. The network entity may then input the supplemental CSI reports to a prediction algorithm to improve beam selection and reduce erroneous predictions. However, triggering the dynamic, aperiodic, semi-persistent, and/or multiple CSI reports may involve the network entity transmitting a first dedicated message (e.g., an activation command) that instructs the UE to start reporting CSI using the smaller periodicity, and a second dedicated message (e.g., a deactivation command) that instructs the UE to cease reporting CSI. A dedicated message may denote a message with an explicit association and/or purpose. For example, a dedicated message for an activation command may be considered a message with an explicit purpose associated with communicating the activation command. Based at least in part on a frequency of expected errors by the predictive methods, the dedicated messages associated with the activation and deactivation commands may consume air interface resources that could otherwise be directed to other devices or transmissions in the wireless network, may introduce data-transfer delays in the wireless network, and/or may reduce a quantity of devices that the wireless network can support.

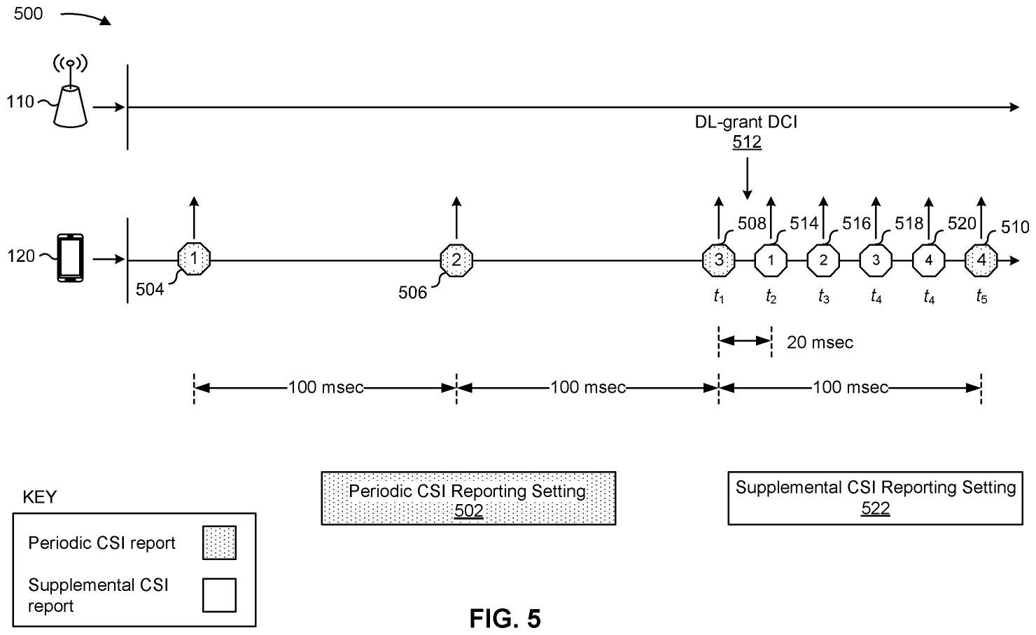

Some techniques and apparatuses described herein provide DL-grant DCI activated multi-instance channel state information reports. In some aspects, a network entity transmits DL-grant DCI that indicates to activate a first multi-instance CSI report (e.g., an SP-CSI report or multiple A-CSI reports) that is based at least in part on a first CSI reporting setting, where the first CSI reporting setting may be related and/or linked to a second CSI reporting setting associated with a second multi-instance CSI report. In some aspects, the second CSI reporting setting may indicate information associated with the first multi-instance CSI report, such as a starting time slot, an ending time slot, and/or a number of multi-instance CSI reports to transmit. Alternatively or additionally, the DL-grant DCI may indicate to deactivate transmitting the first multi-instance CSI report after a specified and/or adaptive time duration. An adaptive time duration may denote a time duration with a length that may be defined as a relative value, such as a time duration associated with a first multi-instance CSI report with an end time that is based at least in part on a second CSI report transmission, as further described with regard to FIG. 5. Activating a CSI report may denote triggering the start of generating and/or transmitting a CSI report. In some aspects, activating a CSI report may denote triggering the activation of a resource for transmission of the CSI report. Deactivating a CSI report may denote triggering the end of generating and/or transmitting a CSI report. In some aspects, deactivating the CSI report may denote triggering the deactivation of a resource for transmission of the CSI report.

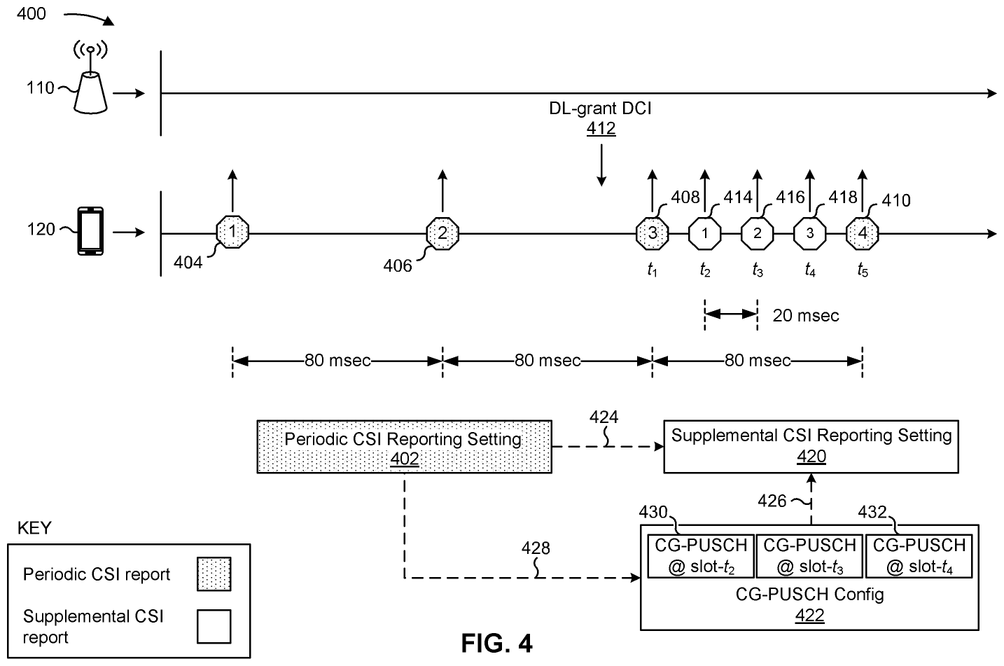

In some aspects, the network entity may transmit the DL-grant DCI to a particular UE, where the DL-grant DCI may indicate physical downlink shared channel (PDSCH) scheduling information associated with the UE. In some aspects, the network entity may include, in the DL-grant DCI, an indication that instructs the UE to activate the first multi-instance CSI report. Subsequently, the network entity may receive the first multi-instance CSI report based at least in part on the first CSI reporting setting. As further described with regard to FIG. 4, a CSI reporting setting may include information that configures how a device (e.g., a UE) generates and/or transmits CSI reports.

In some aspects, a UE receives DL-grant DCI that indicates to activate a first multi-instance CSI report that is based at least in part on a first CSI reporting setting, where the first CSI reporting setting may be related and/or linked to a second CSI reporting setting associated with a second multi-instance CSI report. To illustrate, the DL-grant DCI may indicate to activate, as the first multi-instance CSI report, an SP-CSI report or multiple A-CSI reports. Alternatively or additionally, the DL-grant DCI may indicate to deactivate transmitting the first multi-instance CSI report after a specific and/or adaptive time duration. Based at least in part on receiving the DL-grant DCI that indicates to activate the first multi-instance CSI report, the UE may transmit the first multi-instance CSI report based at least in part on the first CSI reporting setting.

By transmitting the indication to activate and/or deactivate the first multi-instance CSI report (e.g., supplemental CSI reports) in DL-grant DCI, the network entity may reduce an amount of air interface resources used to configure or trigger a UE to generate and/or transmit the first multi-instance CSI reports. To illustrate, the indication in the DL-grant may use fewer air interface resources relative to air interface resources used for a dedicated activation and/or deactivation message. The preserved air interface resources may be assigned to other devices and/or other transmissions, which may reduce data-transfer latency within the wireless network and/or increase a quantity of devices that the wireless network can support.

As indicated above, FIG. 3 is provided as an example. Other examples may differ from what is described with regard to FIG. 3.

FIG. 4 is a diagram illustrating an example 400 of DL-grant DCI activated multi-instance channel state information reports, in accordance with the present disclosure. As shown by the example 400, a base station (e.g., the base station 110 or the apparatus 1000) may instruct a UE (e.g., the UE 120 or the apparatus 900) to activate a multi-instance CSI report (e.g., a SP-CSI report or multiple A-CSI reports) based at least in part on a DL-grant DCI and a configured grant (CG)-physical uplink shared channel (CG-PUSCH). Further, while the example 400 shows a base station communicating with a UE, other examples may include alternate or additional network entities that instruct the UE to activate the first multi-instance CSI report, such as a radio unit, a distributed unit, and/or a central unit of a distributed base station. For example, a central unit or distributed unit may generate an indication to activate a multi-instance CSI report, and a radio unit may transmit the indication to the UE.

A CSI report may include one or more metrics that characterize a frequency band and/or sub-band. Alternatively or additionally, the CSI report may include indications of preferences and/or selections by the UE, such as resource preferences and/or selections. To illustrate, a CSI report may include any combination of CQI, a precoding matrix indicator (PMI), a rank indicator (RI), a layer indicator (LI), a synchronization signal/physical broadcast channel (SS/PBCH) block resource indicator (SSBRI), layer one reference signal received power (LI-RSRP), and/or a CSI-RS resource indicator (CRI). A network entity (e.g., a base station) may instruct and/or configure how a UE generates CSI reports by communicating a CSI reporting setting to a UE.

A CSI reporting setting may indicate one or more CSI reporting configurations (e.g., CSI-ReportConfig) and/or one or more CSI-RS resource settings (e.g., CSI-ResourceConfig). Each CSI-RS reporting configuration may be associated with a single bandwidth part (BWP) and may include one or more parameters for each CSI reporting band specified by the respective CSI-RS reporting configuration. Alternatively or additionally, a CSI reporting configuration may indicate particular reference signals to use for particular measurements and/or particular resources to use for transmitting a CSI report (e.g., PUSCH resources or physical uplink control channel (PUCCH) resources). Some example parameters indicated by a CSI reporting configuration may include, but are not limited to, any combination of a report configuration type (e.g., periodic, semi-persistent, or aperiodic), a codebook configuration, a report quantity, time restriction information, format information (e.g., a single wideband CSI measurement or multiple sub-band CSI measurements), reporting bands (e.g., contiguous or non-contiguous subsets of sub-bands in a BWP), report periodicity, a PUCCH resource list, sub-band size, timing offset for PUSCH reporting, and/or beam reporting configurations.

CSI-RS resource settings may indicate types of reference signals being transmitted by a source device (e.g., the base station 110). Some example CSI-RS resource settings may include, but are not limited to, any combination of a BWP identifier, one or more SSB resources, one or more non-zero power (NZP) CSI-RS resources, and/or a resource type (e.g., periodic, aperiodic, or semi-persistent).

In some aspects, the base station 110 may configure the UE 120 to activate (e.g., generate and/or transmit) different types of multi-instance CSI reports over different time durations. To illustrate, the base station 110 may configure the UE 120 to generate and transmit (1) periodic CSI reports over a longer time duration (e.g., a length of time for which periodic CSI reporting is activated or a lifespan of an active connection between the base station 110 and the UE 120) and (2) supplemental CSI reports over a shorter time duration than the longer time duration (e.g., a portion of the lifespan of the active connection). The periodic CSI reports of item (1) and the supplemental CSI reports of item (2) may be considered types of multi-instance CSI reports. In some aspects, the supplemental CSI reports may be SP-CSI reports or multiple A-CSI reports.

As shown by the example 400, the base station 110 may configure and/or instruct the UE 120 to generate and transmit a periodic multi-instance CSI report based at least in part on a periodic CSI reporting setting 402, such as by transmitting an activation command to the UE 120. In some aspects, the base station 110 may communicate the periodic CSI reporting setting 402 to the UE using a radio resource control (RRC) message. Based at least in part on the periodic CSI reporting setting 402, the UE 120 may periodically generate and transmit multiple CSI reports to the base station 110, such as a first periodic report 404, a second periodic report 406, a third periodic report 408, a fourth periodic report 410, and so forth. As one example, the UE 120 may calculate a periodic time duration of 80 msec (e.g., as shown in the example 400) based at least in part on an ssb-Index-RSRP value indicated in a reportQuantity field of the periodic CSI reporting setting 402 and/or a CSI-ReportPeriodicity AndOffset value associated with a reportConfigType field of the periodic CSI reporting setting 402.

In some aspects, the base station 110 may instruct the UE 120 to activate one or more supplemental multi-instance CSI reports carried by the PUSCH based at least in part on a DL-grant DCI 412. As one example, the base station 110 may set a value of a single, dedicated bit in the DL-grant DCI to a value (e.g., a “1” or a “0”) that indicates to trigger the supplemental CSI reports. As another example, the base station 110 may set a value of a dedicated bit-point in the DL-grant DCI (e.g., a bit-point associated with a DCI field or a bit-point associated with all of the DL-grant DCI) that indicates to trigger the supplemental CSI reports. A dedicated bit and/or a dedicated bit-point denotes a bit and/or a dedicated bit-point with an explicit assignment for an explicit purpose.

Based at least in part on receiving the indication in the DL-grant DCI 412, the UE 120 may generate and transmit the supplemental and/or additional CSI reports, such as supplemental CSI report 414 at time t₂, supplemental CSI report 416 at time t₃, and supplemental CSI report 418 at time t₄. While the example 400 shows the UE 120 transmitting three supplemental CSI reports, alternate examples may include the UE 120 transmitting a single supplemental CSI report, two supplemental CSI reports, or more than three supplemental CSI reports. The UE 120 may generate and/or transmit the supplemental CSI reports based at least in part on a supplemental CSI reporting setting 420. In some aspects, the base station 110 may indicate and/or communicate the supplemental CSI reporting setting 420 to the UE 120. As one example, the base station 110 may communicate the supplemental CSI reporting setting 420 to the UE 120 using an RRC message. To illustrate, the base station 110 may communicate the supplemental CSI reporting setting 420 to the UE 120 using an RRC message and prior to transmitting the DL-grant DCI 412. Communicating the supplemental CSI reporting setting 420 prior to an indication to activate the supplemental CSI reports allows the base station 110 to quickly instruct the UE 120 to activate the supplemental CSI reports (e.g., CSI reports based at least in part on the supplemental CSI reporting setting 420) by using less data to indicate the instructions (e.g., a single bit as compared to separate activation and/or deactivation messages) and by using fewer air interface resources to indicate the instructions as compared to separate activation and/or deactivation messages.

In some aspects, the base station 110 may configure the UE 120 to identify the indication in the DL-grant DCI. As one example, the base station 110 may send an RRC configuration message to the UE 120, where the RRC configuration message indicates to activate the use of DL-grant DCI for triggering the supplemental CSI reports. Activating the use of DL-grant DCI for triggering the supplemental CSI reports may denote that the base station will use the single bit or the bit-point to indicate to activate the supplemental CSI reports. Deactivating the use of DL-grant DCI for triggering the supplemental CSI reports may denote that the base station will refrain from using the single bit and/or the bit-point of the DL-grant DCI to activate the supplemental CSI reports. Thus, the base station 110 may configure a UE to identify a trigger and/or activation indication in the DL-grant DCI (e.g., via an RRC configuration message).

The base station may implicitly indicate to activate a Type 2 CG-PUSCH for transmitting the supplemental CSI reports in a same DL-grant DCI used to activate and/or trigger the supplemental CSI reports. To illustrate, the base station 110 may transmit an RRC communication that indicates a configuration for recurring (e.g., semi-persistent) or periodic resources that the UE 120 may use for the PUSCH transmissions, such as CG-PUSCH configuration 422. A Type 1 CG-PUSCH may denote a CG-PUSCH in which the base station indicates an activation of the recurring or periodic resources in the RRC communication (e.g., implicitly or explicitly). A Type 2 CG-PUSCH may denote a CG-PUSCH in which the base station indicates activation of the recurrent or periodic resources using a DCI communication. In some aspects, the base station 110 may indicate to activate a Type 2 CG-PUSCH in the same DL-grant DCI that indicates to activate the supplemental CSI reports.

As shown by reference number 424, the supplemental CSI reporting setting 420 may be related (e.g., linked) to the periodic CSI reporting setting 402. As one example, the supplemental CSI reporting setting 420 and/or an information element (IE) that includes the supplemental CSI reporting setting 420 may include an identifier (ID) that may be used to specify a linkage to another CSI reporting setting. To illustrate, a field and/or parameter “Refinement-CSI-Report-Setting” of the supplemental CSI reporting setting 420 may be set to an ID value associated with the periodic CSI reporting setting 402 to indicate a linkage and/or relationship between the CSI reporting settings 402 and 420. Based at least in part on the linkage indicated by the field and/or parameter, the UE 120 may calculate and/or determine supplemental CSI reporting behaviors (e.g., a start time to begin transmitting supplemental CSI reports and/or an end time to cease transmitting supplemental CSI reports) based at least in part on the periodic CSI reporting setting 402, such as based at least in part on transmission occurrences indicated by the periodic CSI reporting setting 402. In some aspects, the UE 120 may conditionally use information associated with the periodic CSI reporting setting 402, such as by only using the information associated with the periodic CSI reporting setting 402 when the periodic CSI reporting has been activated and/or is in an active state.

As shown by reference number 426, the supplemental CSI reporting setting 420 may be related and/or linked to the CG-PUSCH configuration 422. As one example, the supplemental CSI reporting setting 420 and/or an IE that includes the supplemental CSI reporting setting 420 may include a CG-PUSCH configuration ID associated with the CG-PUSCH configuration 422. Alternatively or additionally, and as shown by reference number 428, the periodic CSI reporting setting 402 may be related and/or linked to the CG-PUSCH configuration 422. To illustrate, and in a similar manner as described with regard to the reference number 426, the periodic CSI reporting setting 402 and/or an IE that includes the periodic CSI reporting setting 402 may include a CG-PUSCH configuration ID associated with the CG-PUSCH configuration 422 and/or associated with configuration information associated with the CG-PUSCH configuration 422.

The base station 110 may configure and/or instruct the UE 120 to activate SP-CSI reports as the supplemental CSI reports based at least in part on transmitting an indication in DL-grant DCI as further described. To illustrate, based at least in part on the linkage between the CG-PUSCH configuration 422 and the supplemental CSI report setting 420 as shown by the reference number 426, the UE 120 may calculate and/or identify a starting time slot for transmitting the SP-CSI reports based at least in part on a first CG-PUSCH transmission occasion 430. Alternatively or additionally, the UE 120 may transmit the SP-CSI reports using a same slot offset and/or periodicity as indicated by the CG-PUSCH configuration 422 (shown in the example 400 as a 20 msec periodicity). While the example 400 shows the CG-PUSCH configuration 422 specifying three occasions for uplink transmissions via CG-PUSCH, other examples may include a CG-PUSCH configuration indicating more or fewer occasions.

In some aspects, the base station 110 may implicitly indicate a time to deactivate the SP-CSI reports (e.g., the base station 110 does not transmit an explicit indication to deactivate the SP-CSI reports). For example, the UE 120 may calculate an/or identify an ending time slot for transmitting the SP-CSI reports based at least in part on a last CG-PUSCH transmission occasion 432 indicated by the CG-PUSCH configuration 422. The implicit indication of a time to deactivate the SP-CSI reports may reduce signaling between the base station 110 and the UE 120 and subsequently preserve air interface resources for other communications and/or other devices.

The base station 110 may configure and/or instruct the UE 120 to activate multiple consecutive A-CSI reports as the supplemental CSI reports based at least in part on transmitting an indication in DL-grant DCI as further described. In some aspects, the base station 110 may indicate a number of A-CSI reports for the UE 120 to transmit, either explicitly (e.g., in a field of the DL-grant DCI) or implicitly (e.g., the base station 110 does not transmit an explicit indication of a number of A-CSI reports to transmit). To illustrate, based at least in part on the linkage between the CG-PUSCH configuration 422 and the supplemental CSI report setting 420 as shown by the reference number 426, the UE 120 may calculate and/or identify a number of A-CSI reports to transmit based at least in part on a number of CG-PUSCH occasions indicated by the CG-PUSCH configuration 422. As one example, the CG-PUSCH configuration 422 may indicate a periodicity for CG-PUSCH transmissions and/or time duration for activated transmissions based at least in part on a configuredGrantTimer parameter UE 120 may calculate a number of A-CSI reports to transmit based at least in part on a the indicated periodicity and/or the time duration.

In some aspects, and prior to transmitting the indication to activate the supplemental CSI reports, the base station 110 may indicate operation type information to the UE 120. The operation type information may specify one or more operation types associated with the supplemental CSI report. An operation type may denote (1) a type of CSI report to generate and transmit (e.g., SP-CSI or A-CSI) and/or (2) an uplink channel for carrying the CSI report. To illustrate, the operation type information may indicate an SP-CSI CG-PUSCH operation type, an A-CSI CG-PUSCH operation type, and/or an SP-CSI PUCCH operation type (e.g., as further described with regard to FIG. 5). Activating an operation type may denote selecting an operation type (such as a type of CSI report and an uplink channel) for performing the supplemental CSI reports. The base station 110 may indicate the operation type information in an RRC message, in a MAC-CE, and/or in the DL-grant DCI (e.g., a field of the DL-grant DCI) that indicates to activate the supplemental CSI reports.

As one example, the base station 110 may indicate the operation type information in a same RRC message that indicates the supplemental CSI reporting setting 420, in an RRC configuration message, and/or in another RRC message. As another example, the base station 110 may first indicate multiple operation types in an RRC message and then subsequently activate one of the operation types in a MAC-CE. To illustrate, the base station 110 may indicate a set of pre-configured operation types using an RRC message and subsequently indicate to activate a particular pre-configured operation type from the set of pre-configured operation types using a field of a MAC-CE. A pre-configured operation type may denote an operation type that has a shared and/or common definition between at least two devices. For instance, the base station 110 may communicate the definition for the set of pre-configured operation types to the UE 120 using an RRC message and/or by instructing the UE 120 to utilize a common look-up table (LUT), where each entry of the LUT specifies a particular pre-configured operation type. The base station 110 may specify a pre-configured operation type to activate by indicating an entry of the LUT and/or an index from a set of pre-configured operation types communicated in an RRC message.

The UE 120 may prioritize the supplemental CSI report with respect to one or more other transmissions, such as by prioritizing the supplemental CSI report higher or lower than another activated CSI report different from the supplemental CSI report (e.g., another SP-CSI report and/or another A-CSI report), the activated periodic CSI report, a different activated periodic CSI report, a different PUSCH transmission (e.g., a data transmission scheduled to be carried by PUSCH), and/or a different PUCCH transmission. In some aspects, the UE 120 may determine whether to refrain from transmitting the supplemental CSI report based at least in part on a priority of the supplemental CSI report relative to one or more of the other transmissions. To illustrate, the UE 120 may identify that a transmission occasion associated with the supplemental CSI report overlaps with a transmission occasion associated with the one or more other transmissions. In some aspects, the UE 120 may determine to refrain from transmitting the supplemental CSI report in the transmission occasion based at least in part on the supplemental CSI report having a lower priority relative to the one or more other transmissions.

By transmitting an indication in DL-grant DCI, a network entity may quickly instruct a UE to activate multi-instance CSI reports (e.g., SP-CSI or multiple A-CSI reports) transmitted via a CG-PUSCH using fewer air interface resources relative to other mechanisms, such as dedicated activation and/or deactivation messages. Communicating the reporting settings prior to the activation indication also allows the base station to send the indication efficiently and quickly by communicating larger amounts of information (e.g., a reporting setting) up front and prior to the indication, which allows the base station to communicate the indication with fewer resources. The preserved air interface resources may be assigned to other devices and/or other transmissions, which may reduce data-transfer latency within the wireless network and/or increase a quantity of devices that the wireless network can support.

As indicated above, FIG. 4 is provided as an example. Other examples may differ from what is described with regard to FIG. 4.

FIG. 5 is a diagram illustrating an example 500 of DL-grant DCI activated multi-instance channel state information reports, in accordance with the present disclosure. As shown by the example 500, a base station (e.g., the base station 110 or apparatus 1000) may instruct a UE (e.g., the UE 120 or apparatus 900) to activate a multi-instance CSI report (e.g., an SP-CSI report) based at least in part on a DL-grant DCI and a PUCCH. In some aspects, the multi-instance CSI report may be a first multi-instance CSI report that is related and/or linked to a second multi-instance report. The DL-grant DCI may implicitly indicate to deactivate the multi-instance CSI report after a specified or adaptive time duration. While the example 500 shows a base station communicating with a UE, other examples may include alternate or additional network entities that instruct the UE to activate the multi-instance CSI report, such as a radio unit, a distributed unit, and/or a central unit of a distributed base station.

Similar to that described with regard to FIG. 4, the base station 110 may configure and/or instruct the UE 120 to activate a periodic CSI report based at least in part on a periodic CSI reporting setting 502. As one example, the base station 110 may communicate the periodic CSI reporting setting 502 to the UE 120 using an RRC message. Based at least in part on the periodic CSI reporting setting 502, the UE 120 may periodically generate and transmit multiple periodic CSI reports to the base station 110, such as a first periodic report 504, a second periodic report 506, a third periodic report 508, a fourth periodic report 510, and so forth. The periodicity of the CSI reports may be based at least in part on information included in the periodic CSI reporting setting 502, such as an ssb-Index-RSRP value and/or a CSI-ReportPeriodicity AndOffset value. To illustrate, for an RRC configuration of 160 slots per 20 msec, the CSI-ReportPeridocity AndOffset of the periodic CSI reporting setting 502 may indicate an 800 slot periodicity (e.g., resulting in a 100 msec periodicity as shown by the example 500) and a 0-slot slot offset.

In some aspects, the base station 110 may instruct the UE 120 to activate supplemental and/or additional CSI reports carried by PUCCH based at least in part on a DL-grant DCI 512. Similar to that described with regard to FIG. 4, the base station 110 may set a value of a single, dedicated bit or a dedicated bit-point in the DL-grant DCI. Alternatively or additionally, the base station 110 may configure the UE 120 to identify the indication in the DL-grant DCI (e.g., through an RRC configuration message). Based at least in part on identifying the indication in the DL-grant DCI, the UE 120 may activate the supplemental CSI reports carried by PUCCH, such as a first supplemental CSI report 514, a second supplemental CSI report 516, a third supplemental CI report 518, a fourth supplemental CSI report 520, and so forth.

To configure the supplemental CSI reports, the base station 110 may communicate a supplemental CSI reporting setting 522 to the UE 120, such as through an RRC configuration message and/or prior to transmitting the DL-grant DCI 512 to the UE 120. In some aspects, and as further described with regard to FIG. 4, the base station 110 may indicate operation type information to the UE 120, such as a set of pre-configured operation types and/or a particular operation type to activate for the supplemental CSI reports.

In some aspects, the UE 120 may determine a periodicity and starting transmission occasion for transmitting the supplemental CSI reports based at least in part on the supplemental CSI reporting setting 522 and the periodic CSI reporting setting 502. As one example, the UE 120 may obtain a periodicity of the supplemental CSI reports based at least in part on the supplemental CSI reporting setting 522. To illustrate, for an RRC configuration of 160 slots per 20 msec, the CSI-ReportPeridocityAndOffset of the supplemental CSI reporting setting 522 may indicate a 160 slot periodicity (e.g., resulting in a 20 msec periodicity as shown by the example 500) and a 0-slot slot offset. As another example, the UE 120 may calculate a starting occasion for transmitting a first supplemental CSI report 514 based at least in part on the periodic CSI reporting setting 502 and a mathematical assumption that a periodicity of the periodic CSI reports may be evenly divided (e.g., with no remainder) by a periodicity of the supplemental CSI reports.

To illustrate, the UE 120 may identify a transmission occasion for the supplemental CSI report 514 based at least in part on receiving the DL-grant DCI after a first periodic CSI report transmission occasion t₁. In some aspects, the UE 120 may identify the first periodic CSI report transmission occasion t₁ based at least in part on the periodic CSI reporting setting 502. Alternatively or additionally, the UE 120 may identify that a first supplemental CSI report transmission occasion t₂ is closest to the first periodic CSI report transmission occasion t₁ relative to other supplemental CSI report transmission occasions and/or relative to other periodic CSI report transmission occasions. As one example, the UE 120 may identify the first supplemental CSI report transmission occasion t₂ based at least in part on the mathematical assumption that the periodic CSI periodicity (e.g., 100 msec) may be evenly divided by the supplemental periodicity (e.g., 20 msec) such that a time difference between t₁ and t₂ equates to the supplemental CSI report periodicity.

Alternatively or additionally, the UE 120 may determine an ending transmission occasion for transmitting the supplemental CSI reports based at least in part on the supplemental CSI reporting setting 522 and the periodic CSI reporting setting 502. To illustrate, the UE 120 may identify a particular periodic CSI report transmission occasion and determine an ending supplemental CSI report transmission occasion based at least in part on the particular periodic CSI report transmission occasion. As one example, the particular periodic CSI report transmission occasion may be associated with a next periodic CSI report transmission occasion. To illustrate, a periodic CSI report transmission occasion t₅ may be considered a next periodic CSI report transmission occasion based at least in part on the periodic CSI report transmission occasion t₅ being the next periodic CSI report transmission occasion after the first supplemental CSI report transmission occasion t₂. As another example, the base station 110 may indicate the particular periodic CSI report transmission occasion to the UE 120, such as through an RRC message (e.g., an RRC configuration message).

In some aspects, the UE 120 may determine to refrain from transmitting a supplemental CSI report based at least in part on identifying that a supplemental CSI report transmission occasion may overlap with a periodic CSI report transmission occasion. Alternatively or additionally, the UE 120 may determine to refrain from transmitting the supplemental CSI report in the overlapped transmission occasion based at least in part on priority information as further described with regard to FIG. 4. To illustrate, the UE 120 may identify that a fifth supplemental CSI report transmission occurrence overlaps with the periodic CSI report transmission occasion t₅. Based at least in part on identifying the overlap and/or priority information, the UE 120 may refrain from transmitting the supplemental CSI report at the overlapping transmission occasion associated with the periodic CSI report transmission occasion t₅. In some aspects, the UE 120 may continue transmitting supplemental CSI reports after refraining from transmitting one at an overlapping transmission occasion (e.g., the periodic CSI report transmission occasion t₅). For example, the UE 120 may be configured to transmit additional supplemental CSI reports after the periodic CSI report transmission occasion t₅. Thus, the UE 120 may continue transmitting the supplemental CSI reports after refraining from transmitting a CSI report with an overlapping transmission occurrence.

By transmitting an indication in DL-grant DCI, a network entity may instruct a UE to activate multi-instance CSI reports (e.g., SP-CSI) carried by PUCCH using fewer air interface resources relative to other mechanisms, such as dedicated activation and/or deactivation messages. Communicating the reporting settings prior to the activation indication also allows the base station to send the indication efficiently and quickly by communicating larger amounts of information (e.g., a reporting setting) up front and prior to the indication, which allows the base station to communicate the indication with fewer air interface resources. The preserved air interface resources may be assigned to other devices and/or transmissions, which may reduce data-transfer latency within the wireless network and/or increase a quantity of devices that the wireless network can support.

As indicated above, FIG. 5 is provided as an example. Other examples may differ from what is described with regard to FIG. 5.

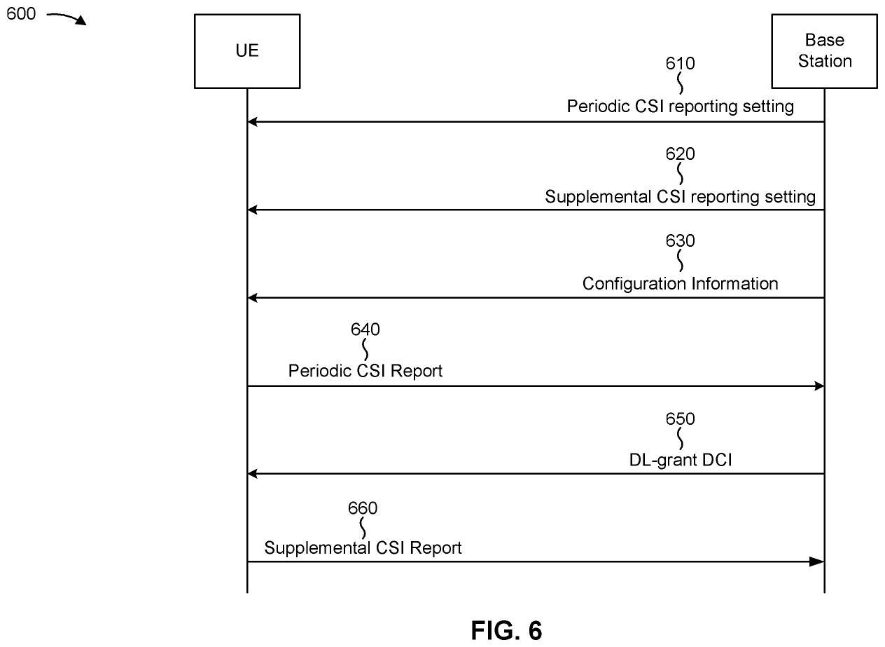

FIG. 6 is a diagram illustrating an example 600 of a wireless communication process between a base station (e.g., the base station 110 or the apparatus 1000) and a UE (e.g., the UE 120 or the apparatus 900) in a wireless network 100, in accordance with the present disclosure. While the example 600 shows a base station participating in the wireless communication process, alternate or additional network entities may participate, such as a radio unit, a distributed unit, and/or a central unit of a distributed base station. The order of signaling shown by the example 600 is not intended to be limiting, and other examples of signaling may be arranged with different ordering relative to the example 600.

As shown by reference number 610, a base station may transmit, and a UE may receive, one or more periodic CSI reporting settings. To illustrate, and as described with regard to FIG. 4 and/or FIG. 5, the base station may transmit an RRC message that indicates the periodic CSI reporting settings and/or that includes an IE that includes the periodic CSI reporting settings. In some aspects, the base station may indicate to activate periodic CSI reports that are based at least in part on the one or more periodic CSI reporting settings. Alternatively or additionally, the base station may indicate uplink resources (e.g., PUCCH or PUSCH resources) for transmitting the periodic CSI reports, such as by indicating the uplink resources using at least the periodic CSI reporting settings, in a same RRC message as the periodic CSI reporting settings, and/or based at least in part on a separate transmission (e.g., a separate RRC message or uplink-grant DCI).

As shown by reference number 620, the base station may transmit, and the UE may receive, one or more supplemental CSI reporting settings as further described with regard to FIG. 4 and FIG. 5. In some aspects, the base station may indicate a relationship and/or linkage between the supplemental CSI reporting settings and the periodic CSI reporting settings, such as by including an ID in a transmission associated with the supplemental CSI reporting settings (e.g., in an RRC message, in an IE that includes the supplemental CSI reporting settings, or in the supplemental CSI reporting settings). As one example, the supplemental CSI reporting settings may include a field and/or parameter for the ID. While the example 600 shows the base station transmitting the supplemental CSI reporting settings separately from the periodic CSI reporting settings, other examples may include the base station transmitting the periodic CSI reporting settings and the supplemental CSI reporting settings in a same transmission (e.g., a same RRC message).

As shown by reference number 630, the base station may transmit, and the UE may receive, additional configuration information. As one example, the base station may transmit operation type information as described with regard to FIG. 4. Alternatively or additionally, the base station may transmit configuration information that indicates to activate the use of DL-grant DCI for triggering the supplemental CSI reports.

In some aspects, the base station may transmit, as part of the additional configuration information, an indication of a Type 2 CG-PUSCH configuration, where the Type 2 CG-PUSCH configuration (e.g., the CG-PUSCH configuration 422) may be associated with a CG-PUSCH configuration ID. The base station may indicate a relationship and/or linkage between the Type 2 CG-PUSCH configuration and the supplemental CSI reporting settings by including the CG-PUSCH configuration ID in the supplemental CSI reporting settings or in an IE that includes the supplemental CSI reporting settings.

In some aspects, the base station may transmit, as part of the configuration information, an indication to activate a particular operation type. For example, as described with regard to FIG. 4 and FIG. 5, the base station may transmit a MAC-CE that includes an indication to activate a particular operation type out of a set of pre-configured operation types, such as an SP CG-PUSCH operation type, an A-CSI CG-PUSCH operation type, and/or an SP-CSI PUCCH operation type.

In some aspects, the base station may configure the UE to identify indications in DL-grant DCI (e.g., an indication to activate supplemental CSI reports). To illustrate, the base station may transmit, as part of the additional configuration information, an RRC configuration message that includes a field associated with activating the DL-grant DCI indication. Based at least in part on receiving the RRC configuration message, the UE may associate a single-bit or a bit-point of DL-grant DCI with an indication to activate supplemental CSI reports.

While the example 600 shows the base station transmitting the additional configuration information separately from the periodic CSI reporting setting and the supplemental CSI reporting setting, other examples may include the base station transmitting the additional configuration information in a same transmission as the periodic CSI reporting settings and/or the supplemental CSI reporting settings (e.g., a same RRC message). Thus, transmitting the additional configuration information may include any combination of one or more RRC messages, MAC-CE, and/or fields within DL-grant DCI.

As shown by reference number 640, the UE may transmit, and the base station may receive, one or more periodic CSI reports that are based at least in part on the periodic CSI reporting setting. To illustrate, the UE may generate and transmit the multiple periodic CSI reports based at least in part on a periodicity indicated by the periodic CSI reporting setting. In some aspects, the UE may transmit the multiple periodic CSI reports using uplink air interface resources indicated by the periodic CSI reporting setting.

As shown by reference number 650, the base station may transmit, and the UE may receive, DL-grant DCI that indicates to activate the supplemental CSI reports. To illustrate, the DL-grant DCI may include a dedicated single-bit indicator or a dedicated bit-point field associated with an indication to activate the supplemental CSI reports. In some aspects, the UE may be configured (e.g., by the base station) to identify the indication in the DL-grant DCI associated with activating the supplemental CSI reports.

As shown by reference number 660, the UE may transmit, and the base station may receive, one or more supplemental CSI reports. In some aspects, the UE may generate and transmit the supplemental CSI reports as SP-CSI CG-PUSCH reports, multiple A-CSI CG-PUSCH reports, or SP-CSI PUCCH reports. As described with regard to FIG. 4, the UE may generate and transmit the supplemental CSI reports based at least in part on a relationship and/or linkage to the periodic CSI reporting setting and/or a CG-PUSCH configuration. Alternatively or additionally, and as described with regard to FIG. 5, the UE may calculate a starting time slot and/or ending time slot for the supplemental CSI reports based at least in part on the supplemental CSI reporting setting and the periodic CSI reporting setting. In some aspects, the UE may prioritize the supplemental CSI reports such that the UE may determine to refrain from transmitting at least one of the supplemental CSI reports associated with the DL-grant DCI indication described with regard to reference number 650.

By transmitting an indication in DL-grant DCI, a network entity may quickly instruct a UE to activate multi-instance CSI reports carried by PUSCH or PUCCH using fewer air interface resources relative to other mechanisms, such as dedicated activation and/or deactivation messages. The preserved air interface resources may be assigned to other devices and/or transmissions, which may reduce data-transfer latency within the wireless network and/or increase a quantity of devices that the wireless network can support.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120 or the apparatus 900) performs operations associated with downlink-grant downlink control information activated channel state information reports.

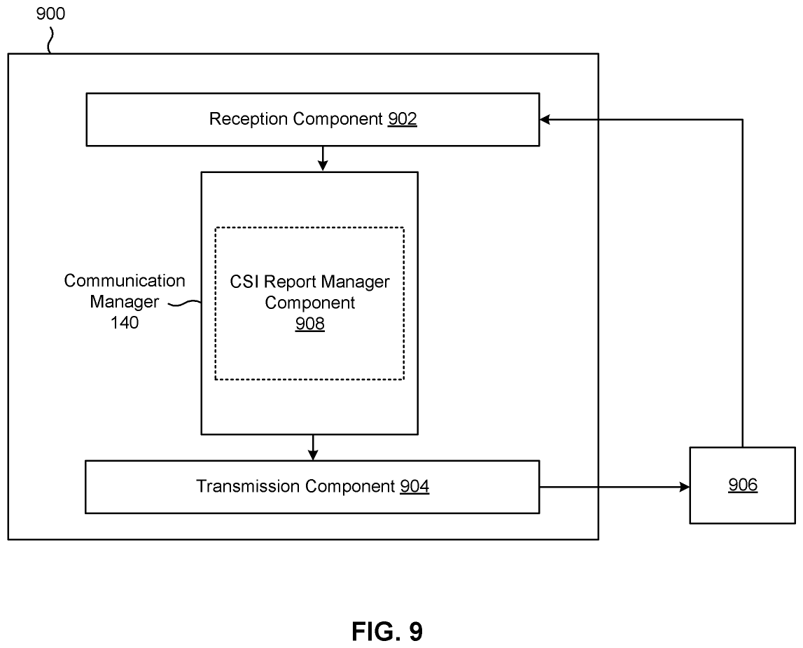

As shown in FIG. 7, in some aspects, process 700 may include receiving, from a network entity, DL-grant DCI that indicates to activate a first multi-instance CSI report that is based at least in part on a first CSI report setting, the first CSI report setting being related to a second CSI report setting associated with a second multi-instance CSI report (block 710). For example, the UE (e.g., using communication manager 140 and/or reception component 902, depicted in FIG. 9) may receive, from a network entity, DL-grant DCI that indicates to activate a first multi-instance CSI report that is based at least in part on a first CSI report setting, the first CSI report setting being related to a second CSI report setting associated with a second multi-instance CSI report, as described above.

As further shown in FIG. 7, in some aspects, process 700 may include transmitting, to the network entity, the first multi-instance CSI report based at least in part on the first CSI report setting (block 720). For example, the UE (e.g., using communication manager 140 and/or transmission component 904, depicted in FIG. 7) may transmit, to the network entity, the first multi-instance CSI report based at least in part on the first CSI report setting, as described above. By receiving and identifying an indication to activate the first multi-instance CSI report in DL-grant DCI, the UE and network entity may use fewer air interface resources to activate the first multi-instance CSI report relative to dedicated messages, which may be used for other devices in the wireless network. Using the preserved air interface resources may reduce data-transfer latencies in the wireless network and improve data throughput.

Process 700 may include additional aspects, such as any single aspect or any combination of aspects described below and/or in connection with one or more other processes described elsewhere herein.

In a first aspect, the first CSI report setting indicates a first reporting periodicity, wherein the second CSI report setting indicates a second reporting periodicity, and wherein the second reporting periodicity is greater than the first reporting periodicity.

In a second aspect, alone or in combination with the first aspect, the DL-grant DCI indicates to activate the first multi-instance CSI report based at least in part on at least one of a single bit of the DL-grant DCI, or a bit-point of the DL-grant DCI.

In a third aspect, alone or in combination with one or more of the first and second aspects, the DL-grant DCI indicates to activate a CG-PUSCH transmission for transmitting the first multi-instance CSI report. Using a same DL-grant DCI to indicate to activate a first-multi-instance CSI report and to activate a CG-PUSCH to carry the first multi-instance CSI report may enable the network entity and UE to reduce an amount of signaling to activate the first multi-instance CSI report, quickly activate the first multi-instance CSI report, and use fewer air interface resources relative to dedicated messages.

In a fourth aspect, alone or in combination with one or more of the first through third aspects, the DL-grant DCI indicates to activate a Type 2 CG-PUSCH.

In a fifth aspect, alone or in combination with one or more of the first through fourth aspects, process 700 includes receiving, from the network entity and prior to receiving the DL-grant DCI, one or more RRC messages that indicate at least one of the first CSI report setting, or the second CSI report setting. Receiving the first and/or second CSI report settings prior to the DL-grant DCI may enable a network entity to transmit larger volumes of information (e.g., the reporting settings) during a time duration that is less time-sensitive and quickly activate the first multi-instance CSI report with fewer data bits.

In a sixth aspect, alone or in combination with one or more of the first through fifth aspects, the one or more RRC messages indicate at least one of a first association between the first CSI report setting and the second CSI report setting, a second association between the first CSI report setting and a Type 2 CG-PUSCH configuration activated by the DL-grant DCI, or a third association between the second CSI report setting and the Type 2 CG-PUSCH configuration.

In a seventh aspect, alone or in combination with one or more of the first through sixth aspects, the DL-grant DCI indicates to activate, as the first multi-instance CSI report, an SP-CSI report using a same time slot offset and a same periodicity as a Type 2 CG-PUSCH.

In an eighth aspect, alone or in combination with one or more of the first through seventh aspects, the DL-grant DCI indicates to activate the SP-CSI report based at least in part on a next transmission opportunity associated with the Type 2 CG-PUSCH, and wherein the DL-grant DCI indicates to deactivate the SP-CSI report based at least in part on a last transmission occasion associated with the Type 2 CG-PUSCH.

In a ninth aspect, alone or in combination with one or more of the first through eighth aspects, the DL-grant DCI indicates to activate, as the first multi-instance CSI report, multiple consecutive aperiodic CSI reports based at least in part on a Type 2 CG-PUSCH.

In a tenth aspect, alone or in combination with one or more of the first through ninth aspects, the DL-grant DCI indicates a number of consecutive aperiodic CSI reports to transmit during one or more transmission opportunities associated with the Type 2 CG-PUSCH.

In an eleventh aspect, alone or in combination with one or more of the first through tenth aspects, process 700 includes determining the number of consecutive aperiodic CSI reports to transmit based at least in part on a configured grant timer associated with the Type 2 CG-PUSCH.

In a twelfth aspect, alone or in combination with one or more of the first through eleventh aspects, in the DL-grant DCI indicates to activate, as the first multi-instance CSI report, an SP-CSI report carried by a PUCCH.

In a thirteenth aspect, alone or in combination with one or more of the first through twelfth aspects, process 700 includes calculating a starting SP-CSI report time slot based at least in part on a first periodicity indicated by the first CSI report setting and a second periodicity indicated by the second CSI report setting.

In a fourteenth aspect, alone or in combination with one or more of the first through thirteenth aspects, calculating the starting SP-CSI report time slot further comprises calculating the starting SP-CSI report time slot based at least in part on the second periodicity being divisible by the first periodicity, and a time difference between the starting SP-CSI report time slot and a second CSI-report time slot associated with the second multi-instance CSI report, closest to the starting SP-CSI report time slot relative to other CSI report time slots associated with the second multi-instance CSI report, being equal to the first periodicity associated with the first CSI report setting.

In a fifteenth aspect, alone or in combination with one or more of the first through fourteenth aspects, process 700 includes deactivating the SP-CSI report based at least in part on a particular second CSI report transmission occasion.

In a sixteenth aspect, alone or in combination with one or more of the first through fifteenth aspects, the particular second CSI report transmission occasion comprises a second CSI-report transmission occasion indicated by an RRC message, or a next available second CSI-report transmission occasion after a starting time slot associated with the SP-CSI report.

In a seventeenth aspect, alone or in combination with one or more of the first through sixteenth aspects, process 700 includes receiving, from the network entity, operation type information that specifies an operation type associated with the first multi-instance CSI report.

In an eighteenth aspect, alone or in combination with one or more of the first through seventeenth aspects, receiving the operation type information further comprises receiving the operation type information in an RRC message and prior to receiving the DL-grant DCI, in a MAC CE and prior to receiving the DL-grant DCI, or in the DL-grant DCI that indicates to activate the first multi-instance CSI report.

In a nineteenth aspect, alone or in combination with one or more of the first through eighteenth aspects, the operation type information indicates, as the operation type, a particular pre-configured operation type from a set of pre-configured operation types.

In a twentieth aspect, alone or in combination with one or more of the first through nineteenth aspects, the operation type information indicates, as the operation type, at least one of an SP-CSI CG-PUSCH operation type, an A-CSI CG-PUSCH operation type, or a SP-CSI PUCCH operation type.

In a twenty-first aspect, alone or in combination with one or more of the first through twentieth aspects, transmitting the first multi-instance CSI report further comprises determining whether to refrain from transmitting the first multi-instance CSI report based at least in part on a priority of the first multi-instance CSI report relative to another transmission.

In a twenty-second aspect, alone or in combination with one or more of the first through twenty-first aspects, the other transmission is at least one of another CSI report that is different from the first multi-instance CSI report, an activated periodic CSI report that is different from the first multi-instance CSI report, an activated aperiodic CSI report that is different from the first multi-instance CSI report, or a data transmission scheduled to be carried by a PUSCH.

In a twenty-third aspect, alone or in combination with one or more of the first through twenty-second aspects, the first multi-instance CSI report is a periodic CSI report, and wherein determining whether to transmit the first multi-instance CSI report based at least in part on the priority of the first multi-instance CSI report is based at least in part on whether the data transmission scheduled to be carried by the PUSCH has at least one air interface resource that at least partially overlaps one or more air interface resources associated with transmitting the first multi-instance CSI report.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network entity, in accordance with the present disclosure. Example process 800 is an example where the network entity (e.g., the base station 110, apparatus 1000, a CU, a DU, or an RU) performs operations associated with DL-grant DCI activated channel state information reports.

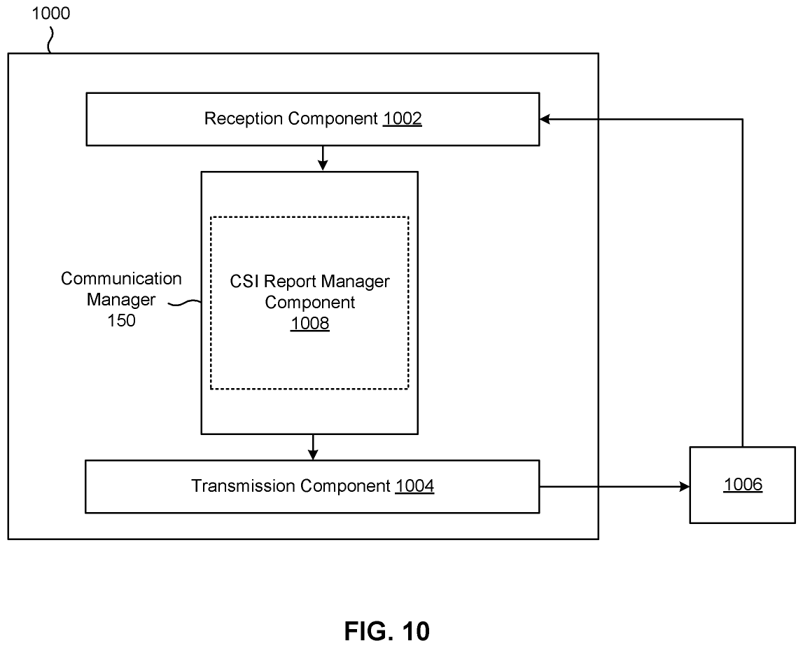

As shown in FIG. 8, in some aspects, process 800 may include transmitting DL-grant DCI that indicates to activate a first multi-instance CSI report that is based at least in part on a first CSI report setting, the first CSI report setting being related to a second CSI report setting associated with a second multi-instance CSI report (block 810). For example, the network entity (e.g., using communication manager 150 and/or transmission component 1004, depicted in FIG. 10) may transmit DL-grant DCI that indicates to activate a first multi-instance CSI report that is based at least in part on a first CSI report setting, the first CSI report setting being related to a second CSI report setting associated with a second multi-instance CSI report, as described above.

As further shown in FIG. 8, in some aspects, process 800 may include receiving the first multi-instance CSI report based at least in part on the first CSI report setting (block 820). For example, the network entity (e.g., using communication manager 150 and/or reception component 1002, depicted in FIG. 10) may receive the first multi-instance CSI report based at least in part on the first CSI report setting, as described above. By transmitting an indication to activate the first multi-instance CSI report in DL-grant DCI, the UE and network entity may use fewer air interface resources to activate the first multi-instance CSI report relative to dedicated messages, which may be used for other devices in the wireless network. Using the preserved air interface resources may reduce data-transfer latencies in the wireless network and improve data throughput.

Process 800 may include additional aspects, such as any single aspect or any combination of aspects described below and/or in connection with one or more other processes described elsewhere herein.

In a first aspect, the first CSI report setting indicates a first reporting periodicity, wherein the second CSI report setting indicates a second reporting periodicity, and wherein the second reporting periodicity is greater than the first reporting periodicity.

In a second aspect, alone or in combination with the first aspect, the DL-grant DCI indicates to activate the first multi-instance CSI report based at least in part on at least one of a single bit of the DL-grant DCI, or a bit-point of the DL-grant DCI.

In a third aspect, alone or in combination with one or more of the first and second aspects, the DL-grant DCI indicates to activate a CG-PUSCH for transmitting the first multi-instance CSI report. Using a same DL-grant DCI to indicate to activate a first-multi-instance CSI report and to activate a CG-PUSCH to carry the first multi-instance CSI report may enable the network entity and UE to reduce an amount of signaling to activate the first multi-instance CSI report, quickly activate the first multi-instance CSI report, and use fewer air interface resources relative to dedicated messages.

In a fourth aspect, alone or in combination with one or more of the first through third aspects, the DL-grant DCI indicates to activate a Type 2 CG-PUSCH.

In a fifth aspect, alone or in combination with one or more of the first through fourth aspects, process 800 includes transmitting, prior to receiving the DL-grant DCI, one or more RRC messages that indicate at least one of the first CSI report setting, or the second CSI report setting. Transmitting the first and/or second CSI report settings prior to the DL-grant DCI may enable a network entity to transmit larger volumes of information (e.g., the reporting settings) during a time duration that is less time-sensitive and quickly activate the first multi-instance CSI report with fewer data bits.

In a sixth aspect, alone or in combination with one or more of the first through fifth aspects, the one or more RRC messages indicate at least one of a first association between the first CSI report setting and the second CSI report setting, a second association between the first CSI report setting and a Type 2 CG-PUSCH configuration activated by the DL-grant DCI, or a third association between the second CSI report setting and the Type 2 CG-PUSCH configuration.

In a seventh aspect, alone or in combination with one or more of the first through sixth aspects, the DL-grant DCI indicates to activate, as the first multi-instance CSI report, a periodic CSI report using a same time slot offset and a same periodicity as a Type 2 CG-PUSCH.

In an eighth aspect, alone or in combination with one or more of the first through seventh aspects, the DL-grant DCI indicates to activate the periodic CSI report based at least in part on a next transmission opportunity associated with the Type 2 CG-PUSCH, and wherein the DL-grant DCI indicates to deactivate the periodic CSI report based at least in part on a last transmission opportunity associated with the Type 2 CG-PUSCH.

In a ninth aspect, alone or in combination with one or more of the first through eighth aspects, the DL-grant DCI indicates to activate, as the first multi-instance CSI report, multiple consecutive aperiodic CSI reports based at least in part on a Type 2 CG-PUSCH.

In a tenth aspect, alone or in combination with one or more of the first through ninth aspects, the DL-grant DCI indicates a number of consecutive aperiodic CSI reports to transmit during one or more transmission opportunities associated with the Type 2 CG-PUSCH.

In an eleventh aspect, alone or in combination with one or more of the first through tenth aspects, in the DL-grant DCI indicates to activate, as the first multi-instance CSI report, a periodic CSI report carried by a PUCCH.

In a twelfth aspect, alone or in combination with one or more of the first through eleventh aspects, process 800 includes transmitting operation type information that specifies an operation type associated with the first multi-instance CSI report.

In a thirteenth aspect, alone or in combination with one or more of the first through twelfth aspects, transmitting the operation type information further comprises transmitting the operation type information in an RRC message and prior to transmitting the DL-grant DCI, in a MAC CE and prior to transmitting the DL-grant DCI, or in the DL-grant DCI that indicates to activate the first multi-instance CSI report.

In a fourteenth aspect, alone or in combination with one or more of the first through thirteenth aspects, the operation type information indicates, as the operation type, a particular pre-configured operation type from a set of pre-configured operation types.

In a fifteenth aspect, alone or in combination with one or more of the first through fourteenth aspects, the operation type information indicates, as the operation type, at least one of a SP-CSI CG-PUSCH operation type, an A-CSI CG-PUSCH operation type, or an SP-CSI PUCCH operation type.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as another UE, a base station, or another wireless communication device) using the reception component 902 and the transmission component 904. As further shown, the apparatus 900 may include the communication manager 140. The communication manager 140 may include one or more of a CSI report manager component 908, among other examples.

In some aspects, the apparatus 900 may be configured to perform one or more operations described herein in connection with FIGS. 3-8. Additionally, or alternatively, the apparatus 900 may be configured to perform one or more processes described herein, such as process 700 of FIG. 7 or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The reception component 902 may receive, from a network entity, DL-grant DCI that indicates to activate a first multi-instance CSI report that is based at least in part on a first CSI report setting, the first CSI report setting being related to a second CSI report setting associated with a second multi-instance CSI report. The transmission component 904 may transmit, to the network entity, the first multi-instance CSI report based at least in part on the first CSI report setting.

The reception component 902 may receive, from the network entity and prior to receiving the DL-grant DCI, one or more RRC messages that indicate at least one of the first CSI report setting, or the second CSI report setting.

The CSI report manager component 908 may determine the number of consecutive aperiodic CSI reports to transmit based at least in part on a configured grant timer associated with the Type 2 CG-PUSCH.

The CSI report manager component 908 may calculate a starting SP-CSI report time slot based at least in part on a first periodicity indicated by the first CSI report setting and a second periodicity indicated by the second CSI report setting.

The CSI report manager component 908 may deactivate the SP-CSI report based at least in part on a particular second CSI report transmission occasion.

The reception component 902 may receive, from the network entity, operation type information that specifies an operation type associated with the first multi-instance CSI report.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network entity, or a network entity may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 150) may include one or more of a CSI report manager component 1008, among other examples.

In some aspects, the apparatus 1000 may be configured to perform one or more operations described herein in connection with FIGS. 3-8. Additionally, or alternatively, the apparatus 1000 may be configured to perform one or more processes described herein, such as process 800 of FIG. 8 or a combination thereof. In some aspects, the apparatus 1000 and/or one or more components shown in FIG. 10 may include one or more components of the network entity described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network entity described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network entity described in connection with FIG. 2. In some aspects, the transmission component 1004 may be co-located with the reception component 1002 in a transceiver.

The transmission component 1004 may transmit DL-grant DCI that indicates to activate a first multi-instance CSI report that is based at least in part on a first CSI report setting, the first CSI report setting being related to a second CSI report setting associated with a second multi-instance CSI report. The reception component 1002 may receive the first multi-instance CSI report based at least in part on the first CSI report setting.

The transmission component 1004 may transmit, prior to receiving the DL-grant DCI, one or more RRC messages that indicate at least one of the first CSI report setting, or the second CSI report setting.

The transmission component 1004 may transmit operation type information that specifies an operation type associated with the first multi-instance CSI report.

The CSI report manager component 1008 may select a reporting setting for the second multi-instance CSI report (e.g., the periodic CSI reporting setting 402 and/or the periodic CSI reporting setting 502). Alternatively or additionally, the CSI report manager component 1008 may select a reporting setting for the first multi-instance CSI report (e.g., the supplemental CSI reporting setting 402 and/or the supplemental CSI reporting setting 522).

The CSI report manager component 1008 may determine a time in which to send a DL-grant DCI that includes an indication to activate the first multi-instance CSI report (e.g., a supplemental CSI report).

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving, from a network entity, downlink-grant (DL-grant) downlink control information (DCI) that indicates to activate a first multi-instance channel state information (CSI) report that is based at least in part on a first CSI report setting, the first CSI report setting being related to a second CSI report setting associated with a second multi-instance CSI report; and transmitting, to the network entity, the first multi-instance CSI report based at least in part on the first CSI report setting.

Aspect 2: The method of Aspect 1, wherein the first CSI report setting indicates a first reporting periodicity, wherein the second CSI report setting indicates a second reporting periodicity, and wherein the second reporting periodicity is greater than the first reporting periodicity.

Aspect 3: The method of Aspect 1 or Aspect 2, wherein the DL-grant DCI indicates to activate the first multi-instance CSI report based at least in part on at least one of: a single bit of the DL-grant DCI; or a bit-point of the DL-grant DCI.

Aspect 4: The method of any one of Aspects 1-3, wherein the DL-grant DCI indicates to activate a configured grant (CG)-physical uplink shared channel (PUSCH) transmission for transmitting the first multi-instance CSI report.

Aspect 5: The method of Aspect 4, wherein the DL-grant DCI indicates to activate a Type 2 CG-PUSCH.

Aspect 6: The method of any one of Aspects 1-5, further comprising: receiving, from the network entity and prior to receiving the DL-grant DCI, one or more radio resource control (RRC) messages that indicate at least one of: the first CSI report setting, or the second CSI report setting.

Aspect 7: The method of Aspect 6, wherein the one or more RRC messages indicate at least one of: a first association between the first CSI report setting and the second CSI report setting, a second association between the first CSI report setting and a Type 2 configured grant (CG)-physical uplink shared channel (PUSCH) configuration activated by the DL-grant DCI, or a third association between the second CSI report setting and the Type 2 CG-PUSCH configuration.

Aspect 8: The method of Aspect 1, wherein the DL-grant DCI indicates to activate, as the first multi-instance CSI report, a semi-persistent (SP)-CSI report using a same time slot offset and a same periodicity as a Type 2 configured grant (CG)-physical uplink shared channel (PUSCH).

Aspect 9: The method of Aspect 8, wherein the DL-grant DCI indicates to activate the SP-CSI report based at least in part on a next transmission opportunity associated with the Type 2 CG-PUSCH, and wherein the DL-grant DCI indicates to deactivate the SP-CSI report based at least in part on a last transmission occasion associated with the Type 2 CG-PUSCH.

Aspect 10: The method of Aspect 1, wherein the DL-grant DCI indicates to activate, as the first multi-instance CSI report, multiple consecutive aperiodic CSI reports based at least in part on a Type 2 configured grant (CG)-physical uplink shared channel (PUSCH).

Aspect 11: The method of Aspect 10, wherein the DL-grant DCI indicates a number of consecutive aperiodic CSI reports to transmit during one or more transmission opportunities associated with the Type 2 CG-PUSCH.

Aspect 12: The method of Aspect 11, further comprising: determining the number of consecutive aperiodic CSI reports to transmit based at least in part on a configured grant timer associated with the Type 2 CG-PUSCH.

Aspect 13: The method of Aspect 1, wherein in the DL-grant DCI indicates to activate, as the first multi-instance CSI report, a semi-persistent (SP)-CSI report carried by a physical uplink control channel (PUCCH).

Aspect 14: The method of Aspect 13, further comprising: calculating a starting SP-CSI report time slot based at least in part on a first periodicity indicated by the first CSI report setting and a second periodicity indicated by the second CSI report setting.

Aspect 15: The method of Aspect 14, wherein calculating the starting SP-CSI report time slot further comprises: calculating the starting SP-CSI report time slot based at least in part on: the second periodicity being divisible by the first periodicity; and a time difference between the starting SP-CSI report time slot and a second CSI-report time slot associated with the second multi-instance CSI report, closest to the starting SP-CSI report time slot relative to other CSI report time slots associated with the second multi-instance CSI report, being equal to the first periodicity associated with the first CSI report setting.

Aspect 16: The method of any one of Aspects 13-15, further comprising: deactivating the SP-CSI report based at least in part on a particular second CSI report transmission occasion.

Aspect 17: The method of Aspect 16, wherein the particular second CSI report transmission occasion comprises: a second CSI-report transmission occasion indicated by a radio resource control (RRC) message; or a next available second CSI-report transmission occasion after a starting time slot associated with the SP-CSI report.

Aspect 18: The method of any one of Aspects 1-17, further comprising: receiving, from the network entity, operation type information that specifies an operation type associated with the first multi-instance CSI report.

Aspect 19: The method of Aspect 18, wherein receiving the operation type information further comprises: receiving the operation type information: in a radio resource control (RRC) message and prior to receiving the DL-grant DCI, in a medium access control (MAC) control element (CE) and prior to receiving the DL-grant DCI, or in the DL-grant DCI that indicates to activate the first multi-instance CSI report.

Aspect 20: The method of Aspect 19, wherein the operation type information indicates, as the operation type, a particular pre-configured operation type from a set of pre-configured operation types.

Aspect 21: The method of Aspect 18, wherein the operation type information indicates, as the operation type, at least one of: a semi-persistent (SP)-CSI configured grant (CG)-physical uplink shared channel (PUSCH) operation type, an aperiodic (A)-CSI CG-PUSCH operation type, or an SP-CSI physical uplink control channel (PUCCH) operation type.

Aspect 22: The method of any one of Aspects 1-21, wherein transmitting the first multi-instance CSI report further comprises: determining whether to refrain from transmitting the first multi-instance CSI report based at least in part on a priority of the first multi-instance CSI report relative to another transmission.

Aspect 23: The method of Aspect 22, wherein the other transmission is at least one of: another CSI report that is different from the first multi-instance CSI report, an activated periodic CSI report that is different from the first multi-instance CSI report, an activated aperiodic CSI report that is different from the first multi-instance CSI report, or a data transmission scheduled to be carried by a physical uplink shared channel (PUSCH).

Aspect 24: The method of Aspect 23, wherein the first multi-instance CSI report is a periodic CSI report, and wherein determining whether to transmit the first multi-instance CSI report based at least in part on the priority of the first multi-instance CSI report is based at least in part on whether the data transmission scheduled to be carried by the PUSCH has at least one air interface resource that at least partially overlaps one or more air interface resources associated with transmitting the first multi-instance CSI report.

Aspect 25: A method of wireless communication performed by a network entity, comprising: transmitting downlink-grant (DL-grant) downlink control information (DCI) that indicates to activate a first multi-instance channel state information (CSI) report that is based at least in part on a first CSI report setting, the first CSI report setting being related to a second CSI report setting associated with a second multi-instance CSI report; and receiving the first multi-instance CSI report based at least in part on the first CSI report setting.

Aspect 26: The method of Aspect 25, wherein the first CSI report setting indicates a first reporting periodicity, wherein the second CSI report setting indicates a second reporting periodicity, and wherein the second reporting periodicity is greater than the first reporting periodicity.

Aspect 27: The method of Aspect 25 or Aspect 26, wherein the DL-grant DCI indicates to activate the first multi-instance CSI report based at least in part on at least one of: a single bit of the DL-grant DCI; or a bit-point of the DL-grant DCI.

Aspect 28: The method of any one of Aspects 25-27, wherein the DL-grant DCI indicates to activate a configured grant (CG)-physical uplink shared channel (PUSCH) transmission for transmitting the first multi-instance CSI report.

Aspect 29: The method of Aspect 28, wherein the DL-grant DCI indicates to activate a Type 2 CG-PUSCH.

Aspect 30: The method of any one of Aspects 25-29, further comprising: transmitting, prior to receiving the DL-grant DCI, one or more radio resource control (RRC) messages that indicate at least one of: the first CSI report setting, or the second CSI report setting.

Aspect 31: The method of Aspect 30, wherein the one or more RRC messages indicate at least one of: a first association between the first CSI report setting and the second CSI report setting, a second association between the first CSI report setting and a Type 2 configured grant (CG)-physical uplink shared channel (PUSCH) configuration activated by the DL-grant DCI, or a third association between the second CSI report setting and the Type 2 CG-PUSCH configuration.

Aspect 32: The method of any one of Aspects 25-27, wherein the DL-grant DCI indicates to activate, as the first multi-instance CSI report, a periodic CSI report using a same time slot offset and a same periodicity as a Type 2 configured grant (CG)-physical uplink shared channel (PUSCH).

Aspect 33: The method of Aspect 32, wherein the DL-grant DCI indicates to activate the periodic CSI report based at least in part on a next transmission opportunity associated with the Type 2 CG-PUSCH, and wherein the DL-grant DCI indicates to deactivate the periodic CSI report based at least in part on a last transmission opportunity associated with the Type 2 CG-PUSCH.

Aspect 34: The method of any one of Aspects 25-27, wherein the DL-grant DCI indicates to activate, as the first multi-instance CSI report, multiple consecutive aperiodic CSI reports based at least in part on a Type 2 configured grant (CG)-physical uplink shared channel (PUSCH).

Aspect 35: The method of Aspect 34, wherein the DL-grant DCI indicates a number of consecutive aperiodic CSI reports to transmit during one or more transmission opportunities associated with the Type 2 CG-PUSCH.

Aspect 36: The method of any one of Aspects 25-27, wherein in the DL-grant DCI indicates to activate, as the first multi-instance CSI report, a periodic CSI report carried by a physical uplink control channel (PUCCH).

Aspect 37: The method of any one of Aspects 25-36, further comprising: transmitting operation type information that specifies an operation type associated with the first multi-instance CSI report.

Aspect 38: The method of Aspect 37, wherein transmitting the operation type information further comprises: transmitting the operation type information: in a radio resource control (RRC) message and prior to transmitting the DL-grant DCI, in a medium access control (MAC) control element (CE) and prior to transmitting the DL-grant DCI, or in the DL-grant DCI that indicates to activate the first multi-instance CSI report.

Aspect 39: The method of Aspect 38, wherein the operation type information indicates, as the operation type, a particular pre-configured operation type from a set of pre-configured operation types.

Aspect 40: The method of Aspect 38, wherein the operation type information indicates, as the operation type, at least one of: a semi-persistent (SP)-CSI configured grant (CG)-physical uplink shared channel (PUSCH) operation type, an aperiodic (A)-CSI CG-PUSCH operation type, or an SP-CSI physical uplink control channel (PUCCH) operation type.

Aspect 41: An apparatus for wireless communication at a device, comprising a processor; memory coupled with the processor; and instructions stored in the memory and executable by the processor to cause the apparatus to perform the method of one or more of Aspects 1-24.

Aspect 42: A device for wireless communication, comprising a memory and one or more processors coupled to the memory, the one or more processors configured to perform the method of one or more of Aspects 25-40.

Aspect 43: An apparatus for wireless communication, comprising at least one means for performing the method of one or more of Aspects 1-24.

Aspect 43: An apparatus for wireless communication, comprising at least one means for performing the method of one or more of Aspects 25-40.

Aspect 44: A non-transitory computer-readable medium storing code for wireless communication, the code comprising instructions executable by a processor to perform the method of one or more of Aspects 1-24.

Aspect 44: A non-transitory computer-readable medium storing code for wireless communication, the code comprising instructions executable by a processor to perform the method of one or more of Aspects 25-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-24.

Aspect 45: A non-transitory computer-readable medium storing a set of instructions for wireless communication, the set of instructions comprising one or more instructions that, when executed by one or more processors of a device, cause the device to perform the method of one or more of Aspects 25-40.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a network entity, downlink-grant (DL-grant) downlink control information (DCI) that indicates to activate a first multi-instance channel state information (CSI) report that is based at least in part on a first CSI report setting, the first CSI report setting being related to a second CSI report setting associated with a second multi-instance CSI report; and
transmit, to the network entity, the first multi-instance CSI report based at least in part on the first CSI report setting.

2. The apparatus of claim 1, wherein the first CSI report setting indicates a first reporting periodicity, wherein the second CSI report setting indicates a second reporting periodicity, and wherein the second reporting periodicity is greater than the first reporting periodicity.

3. The apparatus of claim 1, wherein the DL-grant DCI indicates to activate the first multi-instance CSI report based at least in part on at least one of:
a single bit of the DL-grant DCI; or
a bit-point of the DL-grant DCI.

4. The apparatus of claim 1, wherein the DL-grant DCI indicates to activate a configured grant (CG)-physical uplink shared channel (PUSCH) transmission for transmitting the first multi-instance CSI report.

5. The apparatus of claim 1, wherein the one or more processors are further configured to:
receive, from the network entity and prior to receiving the DL-grant DCI, one or more radio resource control (RRC) messages that indicate at least one of:
the first CSI report setting, or
the second CSI report setting.

6. The apparatus of claim 5, wherein the one or more RRC messages indicate at least one of:
a first association between the first CSI report setting and the second CSI report setting,
a second association between the first CSI report setting and a Type 2 configured grant (CG)-physical uplink shared channel (PUSCH) configuration activated by the DL-grant DCI, or
a third association between the second CSI report setting and the Type 2 CG-PUSCH configuration.

7. The apparatus of claim 1, wherein the DL-grant DCI indicates to activate, as the first multi-instance CSI report, a semi-persistent (SP)-CSI report using a same time slot offset and a same periodicity as a Type 2 configured grant (CG)-physical uplink shared channel (PUSCH).

8. The apparatus of claim 1, wherein the DL-grant DCI indicates to activate, as the first multi-instance CSI report, multiple consecutive aperiodic CSI reports based at least in part on a Type 2 configured grant (CG)-physical uplink shared channel (PUSCH).

9. The apparatus of claim 8, wherein the one or more processors are further configured to:
determine a number of consecutive aperiodic CSI reports to transmit based at least in part on a configured grant timer associated with the Type 2 CG-PUSCH.

10. The apparatus of claim 1, wherein in the DL-grant DCI indicates to activate, as the first multi-instance CSI report, a semi-persistent (SP)-CSI report carried by a physical uplink control channel (PUCCH).

11. The apparatus of claim 10, wherein the one or more processors are further configured to:
calculate a starting SP-CSI report time slot based at least in part on a first periodicity indicated by the first CSI report setting and a second periodicity indicated by the second CSI report setting.

12. The apparatus of claim 10, wherein the one or more processors are further configured to:
deactivate the SP-CSI report based at least in part on a particular second CSI report transmission occasion.

13. The apparatus of claim 1, wherein the one or more processors are further configured to:
receive, from the network entity, operation type information that specifies an operation type associated with the first multi-instance CSI report.

14. The apparatus of claim 1, wherein the one or more processors, to transmit the first multi-instance CSI report, are configured to:
determine whether to refrain from transmitting the first multi-instance CSI report based at least in part on a priority of the first multi-instance CSI report relative to another transmission.

15. An apparatus for wireless communication at a network entity, comprising:
a memory; and
one or more processors, coupled to the memory, configured to:
transmit downlink-grant (DL-grant) downlink control information (DCI) that indicates to activate a first multi-instance channel state information (CSI) report that is based at least in part on a first CSI report setting, the first CSI report setting being related to a second CSI report setting associated with a second multi-instance CSI report; and
receive the first multi-instance CSI report based at least in part on the first CSI report setting.

16. The apparatus of claim 15, wherein the first CSI report setting indicates a first reporting periodicity, wherein the second CSI report setting indicates a second reporting periodicity, and wherein the second reporting periodicity is greater than the first reporting periodicity.

17. The apparatus of claim 15, wherein the DL-grant DCI indicates to activate the first multi-instance CSI report based at least in part on at least one of:
a single bit of the DL-grant DCI; or
a bit-point of the DL-grant DCI.

18. The apparatus of claim 15, wherein the DL-grant DCI indicates to activate a configured grant (CG)-physical uplink shared channel (PUSCH) transmission for transmitting the first multi-instance CSI report.

19. The apparatus of claim 15, wherein the one or more processors are further configured to:
transmit, prior to receiving the DL-grant DCI, one or more radio resource control (RRC) messages that indicate at least one of:
the first CSI report setting, or
the second CSI report setting.

20. The apparatus of claim 19, wherein the one or more RRC messages indicate at least one of:
a first association between the first CSI report setting and the second CSI report setting,
a second association between the first CSI report setting and a Type 2 configured grant (CG)-physical uplink shared channel (PUSCH) configuration activated by the DL-grant DCI, or
a third association between the second CSI report setting and the Type 2 CG-PUSCH configuration.

21. The apparatus of claim 15, wherein the DL-grant DCI indicates to activate, as the first multi-instance CSI report, multiple consecutive aperiodic CSI reports based at least in part on a Type 2 configured grant (CG)-physical uplink shared channel (PUSCH).

22. The apparatus of claim 15, wherein in the DL-grant DCI indicates to activate, as the first multi-instance CSI report, a periodic CSI report carried by a physical uplink control channel (PUCCH).

23. The apparatus of claim 15, wherein the one or more processors are further configured to:
transmit operation type information that specifies an operation type associated with the first multi-instance CSI report.

24. A method of wireless communication performed by a user equipment (UE), comprising:
receiving, from a network entity, downlink-grant (DL-grant) downlink control information (DCI) that indicates to activate a first multi-instance channel state information (CSI) report that is based at least in part on a first CSI report setting, the first CSI report setting being related to a second CSI report setting associated with a second multi-instance CSI report; and
transmitting, to the network entity, the first multi-instance CSI report based at least in part on the first CSI report setting.

25. The method of claim 24, wherein the first CSI report setting indicates a first reporting periodicity, wherein the second CSI report setting indicates a second reporting periodicity, and wherein the second reporting periodicity is greater than the first reporting periodicity.

26. The method of claim 24, further comprising:
receiving, from the network entity and prior to receiving the DL-grant DCI, one or more radio resource control (RRC) messages that indicate at least one of:
the first CSI report setting, or
the second CSI report setting.

27. The method of claim 26, wherein the one or more RRC messages indicate at least one of:
a first association between the first CSI report setting and the second CSI report setting,
a second association between the first CSI report setting and a Type 2 configured grant (CG)-physical uplink shared channel (PUSCH) configuration activated by the DL-grant DCI, or
a third association between the second CSI report setting and the Type 2 CG-PUSCH configuration.

28. A method of wireless communication performed by a network entity, comprising:
transmitting downlink-grant (DL-grant) downlink control information (DCI) that indicates to activate a first multi-instance channel state information (CSI) report that is based at least in part on a first CSI report setting, the first CSI report setting being related to a second CSI report setting associated with a second multi-instance CSI report; and
receiving the first multi-instance CSI report based at least in part on the first CSI report setting.

29. The method of claim 28, wherein the DL-grant DCI indicates to activate a configured grant (CG)-physical uplink shared channel (PUSCH) transmission for transmitting the first multi-instance CSI report.

30. The method of claim 28, wherein the DL-grant DCI indicates to activate, as the first multi-instance CSI report, at least one of:
a periodic CSI report using a same time slot offset and a same periodicity as a Type 2 configured grant (CG)-physical uplink shared channel (PUSCH),
multiple consecutive aperiodic CSI reports based at least in part on a Type 2 CG-PUSCH, or
a periodic CSI report carried by a physical uplink control channel (PUCCH).
